(19) United States
(12) Patent Application Publication
(10) Pub. No.: US 2022/0301018 A1
(43) Pub. Date: Sep. 22, 2022

(54) SYSTEMS AND METHODS FOR ENABLING MULTI-MEDIUM DIGITAL COMMUNICATIONS

(71) Applicant: Information Exchange Network, Inc. (INEX), Edmond, OK (US)

(72) Inventor: Russell E. Latenser, II, Edmond, OK (US)

(21) Appl. No.: 17/696,316

(22) Filed: Mar. 16, 2022

Related U.S. Application Data
(60) Provisional application No. 63/161,760, filed on Mar. 16, 2021.

(51) Int. Cl. G06Q 30/02; H04L 9/40

(52) U.S. Cl. CPC G06Q 30/0277; G06Q 30/0276; H04L 63/083; H04L 63/101

(57) ABSTRACT

A non-transitory computer readable medium storing computer executable code that when executed by a processor cause the processor to receive a message conforming to requirements of a first communication channel. The message is associated with an account having pre-registered information identifying a second communication channel. The computer executable code enable the message to be communicated through the first communication channel; and enable the message to be communicated through the second communication channel.

### INCORPORATION BY REFERENCE

This application claims priority to U.S. Provisional Application Ser. No. 63/161,760 filed on Mar. 16, 2021, the entire contents being hereby expressly incorporated herein by reference.

### BACKGROUND

In billboard advertising, a user, generally a commercial client, submits a particular advertisement for an ad campaign to a billboard manager. The billboard manager then, through a lengthy process, reviews and approves the ad, which is then placed on a billboard. Billboard ads have traditionally been exclusive to a particular billboard for a set time frame, generally a set number of days, weeks, or months.

With the advent of digital billboards, a particular billboard can now run numerous ad campaigns, with each campaign providing a single image for a specific time frame and, in some instances, a time of day, during which the billboard ad for a particular ad campaign is displayed. This process, however, still has the limitations that each ad for the ad campaign is submitted to the billboard manager, who must approve the billboard ad. Additionally, the user, having created the billboard ad, which may be part of a larger marketing strategy, has to create ads for other ad mediums that are not directly interconnected, particularly social media.

Additionally, traditional billboard advertising has targeted only commercial clients. Historically, non-commercial users cannot deliver via an automated presentation or celebration of personal moments onto billboards.

Moreover, traditional billboard ads, being single, static ads, limit users to a single ad campaign, that is, once an ad has been approved for a particular time, duration, and location, the billboard ad is not changed. As such, traditional billboard ads do not allow users to easily update or modify billboard ads, or to change out billboard ads to target multiple demographics.

Therefore, there exists a need for a system and method to allow users to generate and enable a multi-medium advertisement or message.

### SUMMARY

The problem of having to create ads or messages for individual messaging channels is overcome by a system that generates a message for a primary communication channel, and that includes pre-registration of at least one secondary communication channel, whereby a message approved for distribution on the primary communication channel is automatically supplied to the at least one secondary communication channel for enhanced distribution. In some embodiments, the disclosed system is designed to a) provide businesses or individuals a way to upload and modify their own advertising or message campaigns, b) eliminate several existing processes that require billboard company or manager intervention, c) connect sign media presentations directly to client social media accounts, and d) network all client social media accounts by delivering the same message to social media accounts of all clients having social media pre-registered in the system.

### BRIEF DESCRIPTION OF SEVERAL VIEWS OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a block diagram of an exemplary communication system constructed in accordance with the present disclosure.

FIG. 2 is a block diagram of an exemplary computer system for use with the communication system of FIG. 1.

FIG. 3 is a block diagram of an exemplary embodiment of a portion of the communication system constructed in accordance with the present disclosure.

FIG. 4 is a flow diagram of an exemplary approval process in accordance with the present disclosure.

FIGS. 5A-5E depict a flow diagram of an exemplary embodiment of a multi-medium communication system in accordance with the present disclosure.

FIGS. 6A-E depict a flow diagram of another exemplary embodiment of the multi-medium communication system in accordance with the present invention.

FIGS. 7A-B depict an account management module 300 in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description, and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

A programming language is a set of commands, instructions, and other syntax used to create software. Languages that programmers use to write code are called “high-level languages.” High-level language code, which is designed to be read and understood by programmers, is compiled into a “low-level language,” which is recognized directly by the computer hardware as computer readable instructions. This allows programmers to write source code in a more natural fashion, using logical words and symbols. Examples of high-level languages include C++, Java, Perl, and PHP. Low-level languages include assembly and machine languages.

Software may include one or more computer readable instructions that when executed by one or more components cause the component to perform a specified function. It should be understood that the algorithms described herein may be stored on one or more non-transitory computer readable medium. Exemplary non-transitory computer readable mediums may include random access memory, read only memory, flash memory, and/or the like. Such non-transitory computer readable mediums may be electrically based, magnetically based, optically based, and/or the like. Software modules are reusable portions of computer executable code having one or more specific functions.

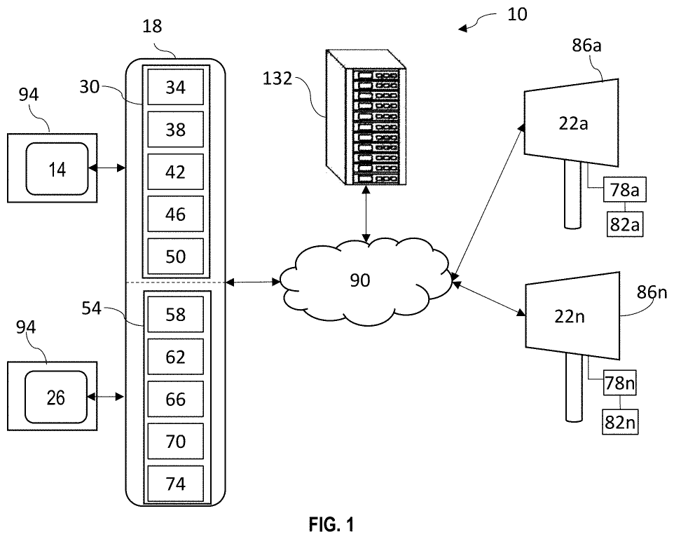

Referring now to the drawings and in particular to FIG. 1, shown therein is a functional diagram of an exemplary embodiment of a communication management system 10 generally comprising an admin controller 14 communicably coupled to a management module 18, which is in turn communicably coupled to one or more digital signage 22a-n, and a client controller 26, communicably coupled to the management module 18. For simplicity, a user connecting to the admin controller 14 will generally be described as an admin and a user connecting to the client controller 26 will generally be described as a client. Additionally, while the admin and the client may be referred to in singular form, it is understood that there may be more than one admin and more than one client. In one embodiment, the one or more digital signage 22a-n is a primary communication channel and may be one or more digital billboard.

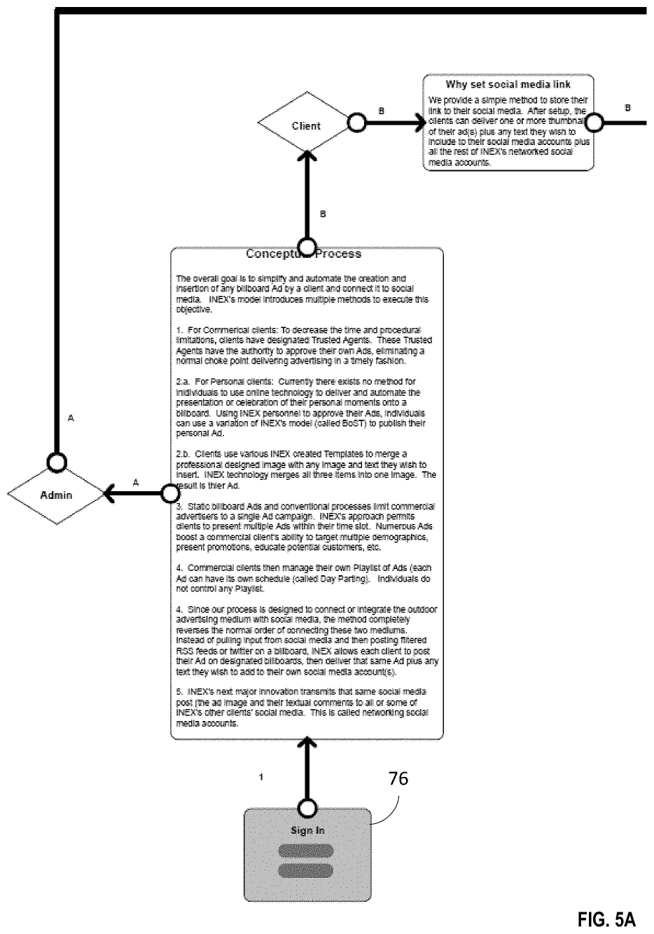

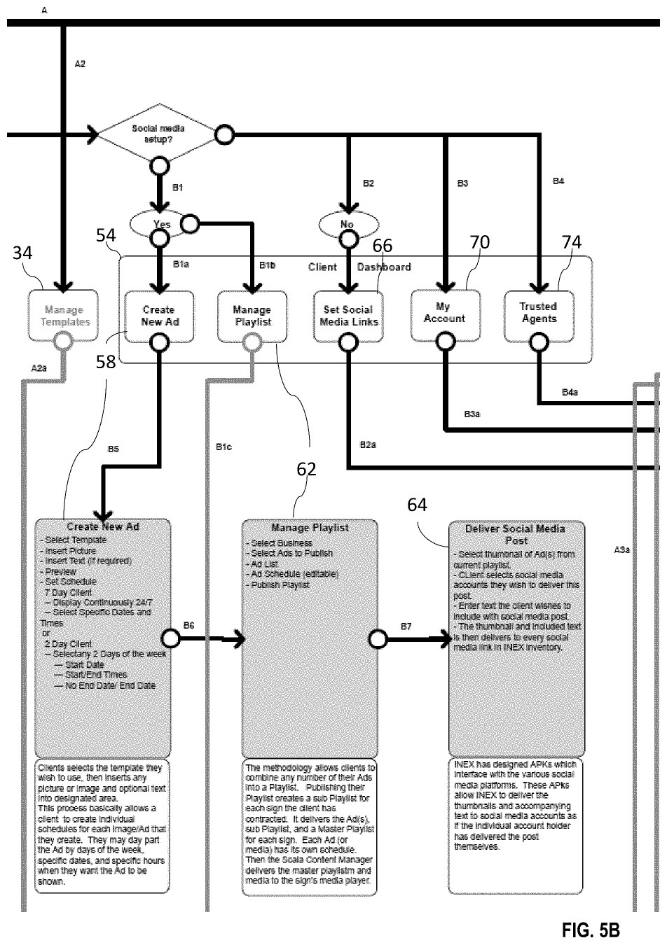

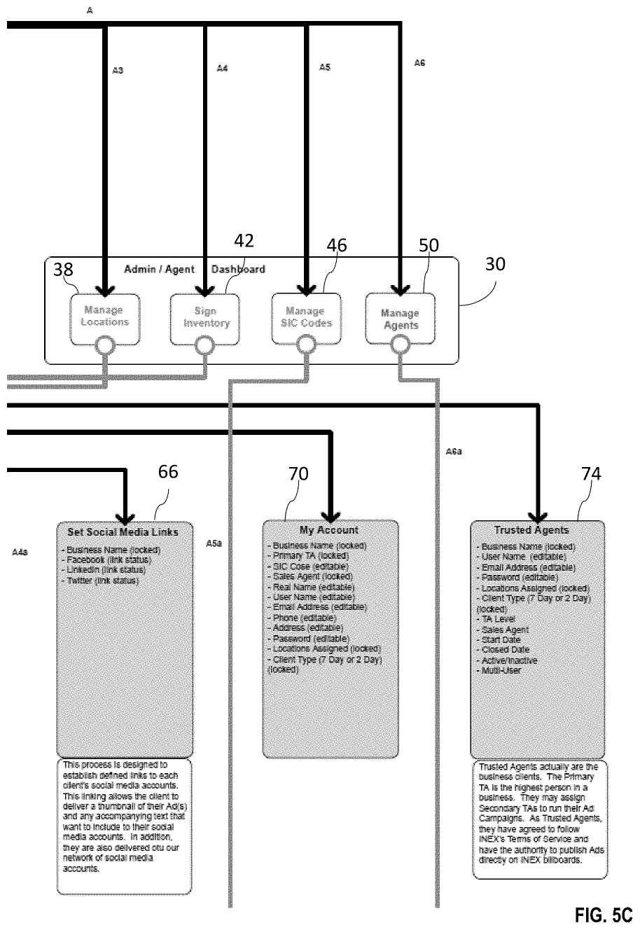

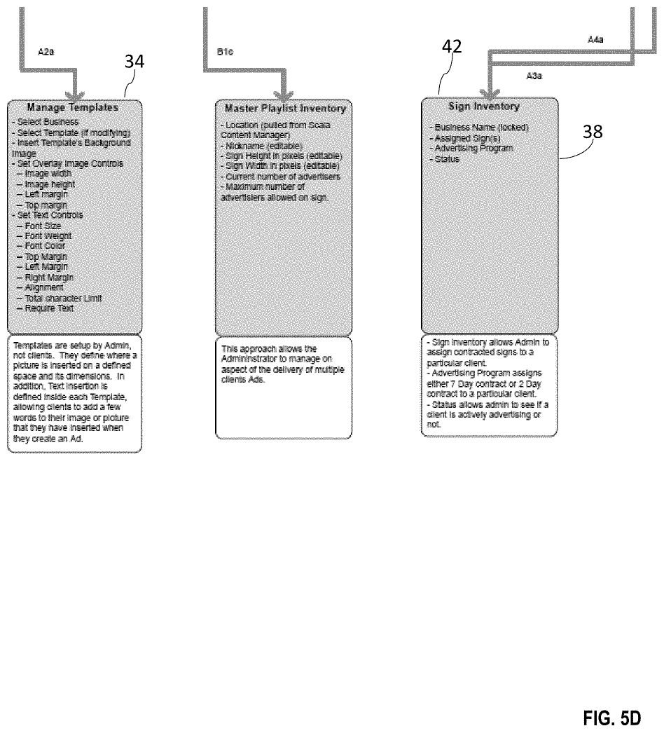

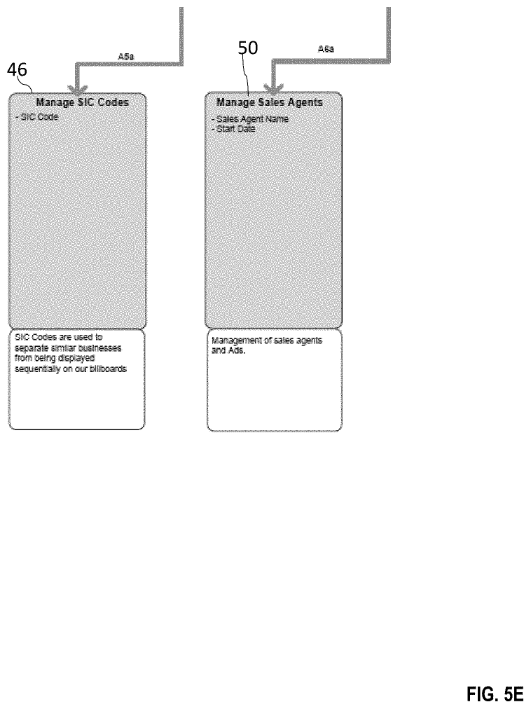

In one embodiment, the admin, connecting to the admin controller 14, is presented with an admin dashboard 30 (shown in FIG. 5C) and is provided with access to a manage templates module 34 (shown in FIG. 5B), a manage locations module 38 (shown in FIG. 5C), a sign inventory module 42 (shown in FIG. 5C), a manage Standard Industrial Codes (SIC) codes module 46 (shown in FIG. 5C), and a manage agents module 50 (shown in FIG. 5C). In one embodiment, one or more of the manage templates module 34, the manage locations module 38, the sign inventory module 42, the manage SIC codes module 46, and the manage agents module 50 is combined with one or more of the other module.

In one embodiment and as shown in FIG. 5D, the manage templates module 34 is a module of software that enables the admin to manage one or more message template. Each message template allows customization of one or more property of a message. In one embodiment, the manage templates module 34 enables the admin to select a business, if the admin is a member of more than one business and create a new message template, or if the admin desires to modify a particular previously created message template, to select the particular message template. The admin may then set a background image property for the message template, set one or more overlay image control property, insert one or more text control, and, for each text control, set one or more text control property.

In one embodiment, the one or more overlay image control property includes at least an overlay image width property, an overlay image height property, an overlay image left margin property, and an overlay image top margin property.

In one embodiment, the one or more text control property includes at least a font size property, a font weight property, a font color property, a text top margin property, a text left margin property, a text right margin property, a text alignment property, a text total character limit property, and a required text property to indicated whether a particular one of the one or more text control is a required element of the message template.

In one embodiment, the message template is setup by the admin, and not setup by the client. The admin, by setting one or more property of the message template, defines where an image is inserted within the message template and dimensions of the image. By setting up the one or more text control, the admin provides the user with a location to insert one or more text within the message template.

In one embodiment and as shown in FIG. 5D, the manage locations module 38, enables the admin to manage each of the one or more digital signage 22a-n. The manage locations module 38 enables the admin to select a particular digital signage 22 of the one or more digital signage 22a-n and set a nickname property, set a sign height property corresponding to the number of pixels available for the particular digital signage 22 in a vertical direction, and set a sign width property corresponding to the number of pixels available for the particular digital signage in a horizontal direction. In one embodiment, the manage locations module 38 further enables the admin to view the current number of advertisers utilizing the particular digital signage, as well as set the maximum number of advertisers allowed to utilize the particular digital signage.

In one embodiment, the manage locations module 38 enables the admin to set an availability schedule for the particular digital signage 22 in predetermined time intervals. In some embodiments, the predetermined time intervals may be 1 second, 5 seconds, 10 seconds, 15 seconds, 30 seconds, 1 minute, 5 minutes, 15 minutes, 30 minutes, 1 hour, 1 day, 1 week, 1 month, 1 year, or any time interval between or some combination thereof.

In one embodiment and as Shown in FIG. 5D, the sign inventory module 42 enables the admin to view a list of the one or more digital signage 22a-n assigned to the business, view the one or more client having a message campaign on each of the one or more digital signage 22a-n and see a sign status of each of the one or more digital signage 22a-n. The sign status may include information such as whether the particular digital signage 22 is in communication with the management module 18, an amount of time for which the particular digital signage 22 does not have a message campaign enabled, and/or the like.

In one embodiment and as shown in FIG. 5E, the manage SIC codes module 46 provides the admin an interface to show an SIC code for each message campaign on each of the one or more digital signage 22a-n. By comparing SIC codes for various message campaigns, the admin can ensure that sequential digital signage messages on the particular digital signage 22 are not associated with similar businesses. For example, the admin can see whether two sequential digital signage messages are associated with the same business industry and, if so, separate the two sequential digital signage messages. A SIC code is the Standard Industrial Classification four-digit code that categorizes industries that a particular company or organization belongs to based on that particular company's or organization's business activities.

In one embodiment and as shown in FIG. 5E, the manage agents module 50 provides an interface for the admin to manage one or more sales agent. The manage agents module 50 may provide an interface to the admin that includes information for each of the one or more sales agent, such as a sales agent name and a sales agent start date, for example.

In one embodiment, the client, connecting to the client controller 26, is presented with a client dashboard 54 (shown in FIG. 5B) and is provided with access to a create new message module 58, a manage playlist module 62, a secondary channel connector 66, a my account module 70, and a trusted agents module 74. In one embodiment, one or more of the create new message module 58, the manage playlist module 62, the secondary channel connector 66, the my account module 70, and the trusted agents module 74 is combined with one or more other module.

In one embodiment as shown in FIG. 5B, if the client has already enabled a secondary channel connector, the client is presented with the create new message module 58, which provides an interface for the client to create a new digital signage ad. The create new message module 58 provides the interface to allow the client to create a new digital signage message by selecting a digital signage template from one or more digital signage templates, inserting a picture into the digital signage template, and inserting text into the digital signage template. The client can then preview the new digital signage message, set a schedule for the new digital signage ad. In one embodiment, the client can select from one or two schedules, a seven-day schedule and a two-day schedule. The seven-day schedule may include, for example, a schedule to display the new digital signage message continuously for an entire day at a time and for an entire week. The client may select a start data and time for the new digital signage ad. The two-day schedule may include, for example, a schedule to display the new digital signage message on any two particular days of the week and may include a start date, a start time, an end date, an end time, and/or no end date. By adjusting the selected schedule, the client may day part the new digital signage message by days of the week, specific dates, and specific hours when the client wants the new digital signage message to be shown. Once selected, the new digital signage message is placed on a message playlist for the client.

In one embodiment and as shown in FIG. 5B, the manage playlist module 62 provides an interface for the client to manage the message playlist. The manage playlist module 62 enables the client to select a business for which the client has access, select one or more digital signage message of the message playlist to publish, publish the selected one or more digital signage message and/or publish the message playlist. The manage playlist module 62 may further provide the client a list each of the digital signage messages in the message playlist as well as a message schedule for each of the one or more digital signage messages in the message playlist. In this manner, the manage playlist module 62 allows the client to combine one or more of their digital signage messages into a particular message playlist. When the client publishes the particular message playlist, a sub-playlist is created for each of the digital signage 22a-n for which the client wants the particular message playlist to be presented.

In one embodiment, the management module 18 combines each sub-playlist of each client for a particular one of the one or more digital signage 22a-n into a master playlist for that particular digital signage 22. Each message of the master playlist may have its own schedule, which may include a number of displays of the message and a duration of each display, for example. The management module 18 may then communicate to the particular digital signage 22 and cause the particular digital signage 22 to store the master playlist and display each message of the master playlist as needed.

In one embodiment, if the client has already enabled a secondary channel connector, when the client submits the sub-playlist for the particular one of the one or more digital signage 22a-n, the management module 18, and or the manage playlist module 62, triggers a secondary channel distribution module 64 to deliver one or more message of the sub-playlist to at least one secondary communication channel, e.g., as a social media post. In one embodiment, the client may select one or more thumbnail of a message from the sub-playlist, select one or more enabled secondary channel connector, enter any additional text as part of the social media post, and cause the message, thumbnail, and additional text to be delivered to each of the selected enabled secondary channel connector as a social media post.

In some embodiments, the secondary channel distribution module 64 delivers one or more message of the sub-playlist to one or more secondary communication channel associated with one or more secondary channel connector for one or more other client. For example, a first client may enable a social media platform, such as Facebook, as a first secondary channel connector and a second client may enable a social media platform, such as Twitter, as a second secondary channel connector. The first client may submit a sub-playlist thus triggering the secondary channel distribution module 64 to deliver one or more message of the sub-playlist to both the first secondary channel connector, i.e., Facebook, and the second secondary channel connector, i.e., Twitter, and/or the second client may submit a second sub-playlist thereby triggering the secondary channel distribution module 64 to deliver one or more second message of the second sub-playlist to both the first secondary channel connector, i.e., Facebook, and the second secondary channel connector, i.e., Twitter. Thus, each client can deliver one or more message from the client's sub-playlist that client's one or more secondary communication channel as well as to one or more other client's at least one secondary communication channel. In this manner, each client can deliver one or more message to a larger number of social media followers than to that client's social media followers alone.

In some embodiments, when the client submits a sub-playlist, the secondary channel distribution module 64 delivers one or more message of the sub-playlist to all secondary channel connectors for each secondary communications channel.

In one embodiment and as shown in FIG. 5B, and in particular if the client has not already enabled a secondary channel connector, the secondary channel connector 66 provides an interface for the client to link a client account of the client in the management module 18 to one or more secondary communication channel for the client. In some embodiments, the secondary communication channel may be one or more social media platform. For example, as shown in FIG. 5C, the client may link their Facebook account as a first secondary communication channel, their Twitter account as a second secondary communication channel, their LinkedIn account as a third secondary communication channel, or the like. It is understood that the present disclosure is not limited to only the listed social media platforms as the secondary communication channel and that in the near future, one or more new social media platforms may be developed which may be connected to as the secondary communication channel. In one embodiment, the secondary channel connector 66 may be used with any social media platform that provides an API for such functionality. In one embodiment, the secondary channel connector 66 defines at least one connection and at least one permission for one or more secondary communication channel, e.g., social media platform to connect the client to the social media platform. Additionally, the secondary channel connector 66 enables the client to select one or more digital signage message, automatically convert the selected digital signage message into a communication for each of the one or more secondary communication channel, and submit the communication for each of the one or more secondary channel connector to the secondary communication channel.

In one embodiment and as shown in FIG. 5B and FIG. 5C, the my account module 70 provides an interface for the client to view and/or set one or more property relates to their client account. For example, the my account module 70 may provide an interface for the client to view their business name property, view their primary trusted agent property, view and/or edit their SIC code property, view their sales agent information, view and/or either their name, view and/or edit their user name, view and/or edit their email address, view and/or edit their phone number, view and/or edit their address, edit their password, view their locations, and view their schedule type, e.g., seven-day or two-day.

In one embodiment and as shown in FIG. 5B and FIG. 5C, the trusted agents module 74 provides an interface for the client to view or edit one or more trusted agent property. In one embodiment, the trusted agents module 74 provides an interface to view the business name, view and/or edit a username, view and/or edit an email address, edit a password, view assigned locations, view schedule type, e.g., seven-day or two-day, view a trusted agent level, view an assigned sales agent, view a start date, view a closed date, view an active/inactive status, and/or some combination thereof.

In one embodiment, a trusted agent corresponds to a business client. A trusted agent level of primary trusted agent may correspond to a highest permission. In one embodiment, the primary trusted agent may assign one or more secondary trusted agent to run and/or manage a particular digital signage message campaign. In one embodiment, each trusted agent has the authority to publish one or more digital signage message, one or more sub-playlist, and one or more message playlist, for one or more of the digital signage 22a-n.

In one embodiment, the management module 18 provides one or more login interface 76 as shown in FIG. 5A for the user to log into the management module 18. If the user logs into the management module 18 and has permissions as an administrator, the user is logged in as the admin and directed to the admin dashboard; however, if the user logs into the management module 18 and has permissions as a client, then the user is logged in as the client and directed to the client dashboard 54. The management module 18 may further provide an interface for the user if the user has forgotten their password to log into the management module 18 utilizing current best practices. For example, if the user has forgotten their password, the management module 18 may request the user's email address, and if the user enters an email address corresponding to an email address of either an admin or a client, may email a password reset link to the user.

In some embodiments, the management module 18 implements additional security such as two-factor authentication, also referred to as 2FA.

In one embodiment, each of the one or more digital signage 22a-n generally comprises at least a processor 78, a memory 82 and a display 86. Referring again to FIG. 1, the digital signage 22a includes a processor 78a coupled to a memory 82a and a display 86a. The display 86 has a sign height in pixels corresponding to the number of pixels of the display 86 in the vertical direction and a sign width in pixels corresponding to the number of pixels of the display 86 in the horizontal direction.

In one embodiment, the memory 82 is a non-transitory computer readable medium. The memory 82 may store one or more software having computer executable code, that when executed by the processor 78 causes the processor to implement one or more method described below.

In one embodiment, the management module 18 is communicably coupled to the one or more digital signage 22a-n via a network 90. In one embodiment, the network 90 is the Internet. It should be noted, however, that the network 90 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

In one embodiment, the admin controller 14 and/or the client controller 26 is implemented on a computing device 94. In one embodiment, the computing device 94 is a desktop computer, a laptop computer, a tablet, a phablet, a cellular telephone, and/or the like, described in more detail below.

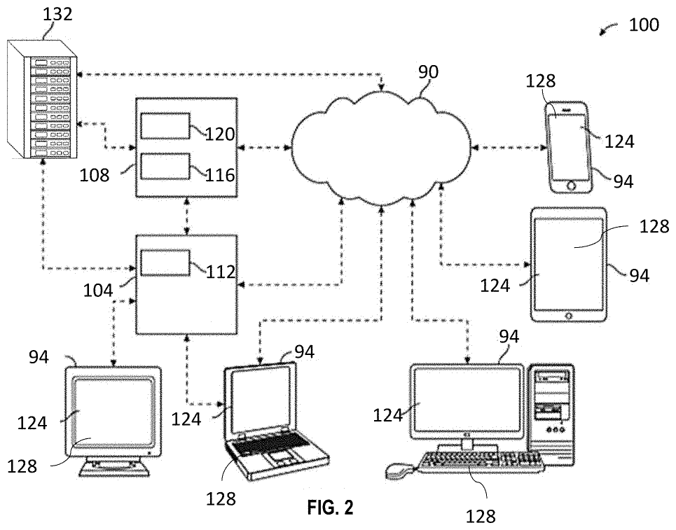

Referring now to FIG. 2, shown therein is a diagram of an exemplary embodiment of the management module 18 constructed in accordance with the present disclosure. In one embodiment, the management module 18 may be carried out on one or more computer system 100. The computer system 100 may comprise one or more computer processor 104, and one or more non-transitory memory 108. As shown in FIG. 2, the computer processor 104 may include (or be communicatively coupled with) one or more communication component 112. The non-transitory memory 108 may store data in one or more database 116 and include one or more software 120. The computer system 100 may include the network 90 enabling bidirectional communication between the computer processor 104 and the non-transitory memory 108 with a plurality of user devices 94. The user devices 94 may communicate via the network 90 and/or may display information on a screen 124. The computer processor 104 or multiple computer processors 104 may or may not necessarily be located in a single physical location.

The computing device 94 has at least the display 124 as a visual feedback device, and an interface device 128, such as, by way of example only, a touch-screen component wherein the display 124 is combined with the interface device 128 such that the user may interact with the display 124 to interface with the computing device 94. In one embodiment, the interface device 128 is any human interface device and may include a keyboard, a mouse, or the like. In other embodiments, the computing device 94 may be in communication with one or more interface device 128 providing an interface through which the user may interact with the computing device 94 by, for example, a speech interaction, a noise interaction, a touch interaction, and/or a movement interaction near the computing device 94. In one embodiment, the display 124 and/or the computing device 94 include one or more of an auditory feedback device, a haptic feedback device, a somatosensory feedback device, and/or an olfactory feedback device.

In one embodiment, the computer processor 104 and the non-transitory memory 108 may be implemented with a server system 132 having multiple servers in a configuration suitable to provide a commercial computer-based business system such as a commercial web-site and/or data center.

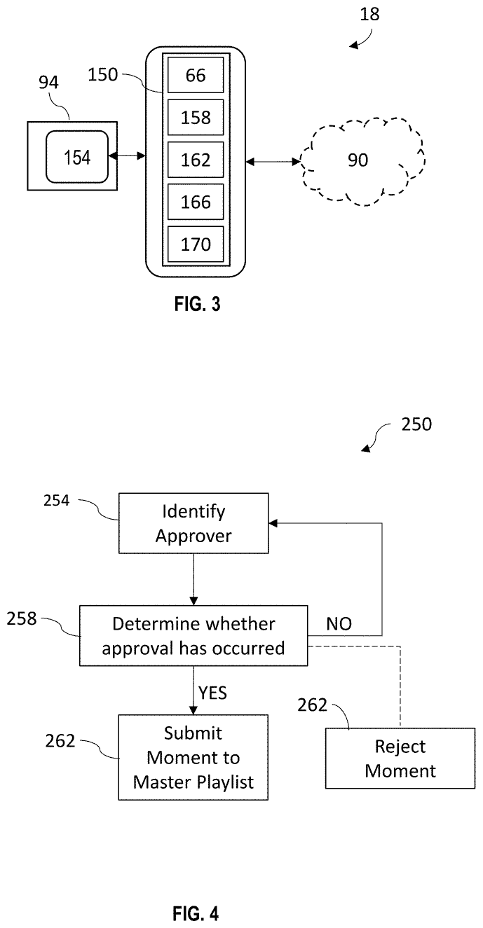

Referring now to FIG. 3, shown therein is a functional block diagram of an exemplary embodiment of the management module 18 constructed in accordance with the present disclosure, the management module 18 further comprising an individual dashboard 150. The individual dashboard 150 is a software module of the management module 18 operable to provide an interface to an individual to enable the individual to manage a digital signage ad. The individual is a user who may not be associated with a business and/or the digital signage message is for personal purposes. Here, the individual may access the individual dashboard 150 of the management module 18 via an individual controller 154, which may be implemented as part of the computing device 94 as described above in relation to the client controller 26 and the admin controller 14. As used herein, a moment is a message similar to a digital signage message; however, the moment provides a notification of a significant personal moment of the individual.

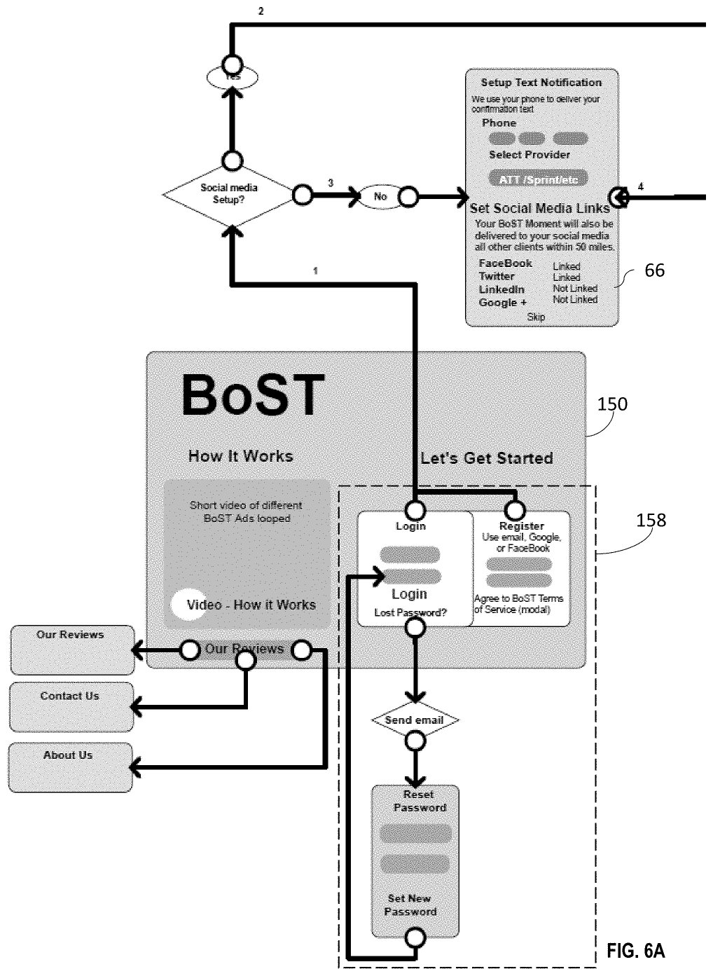

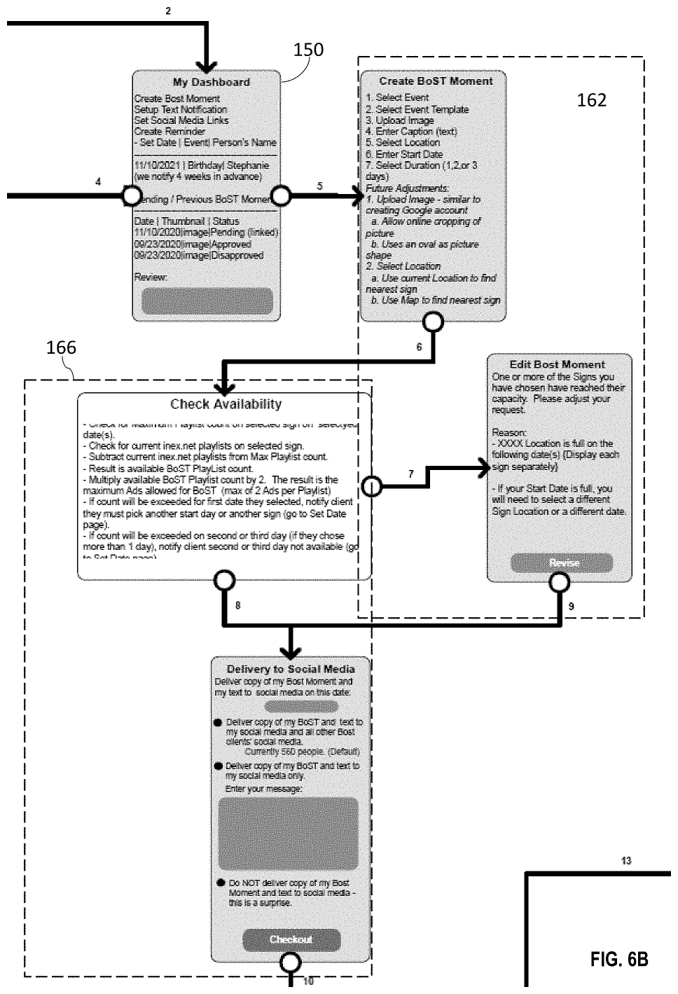

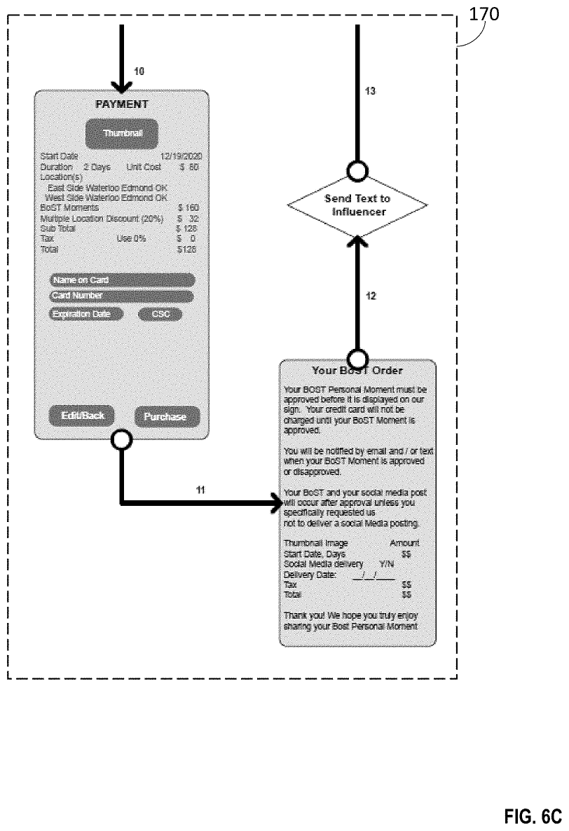

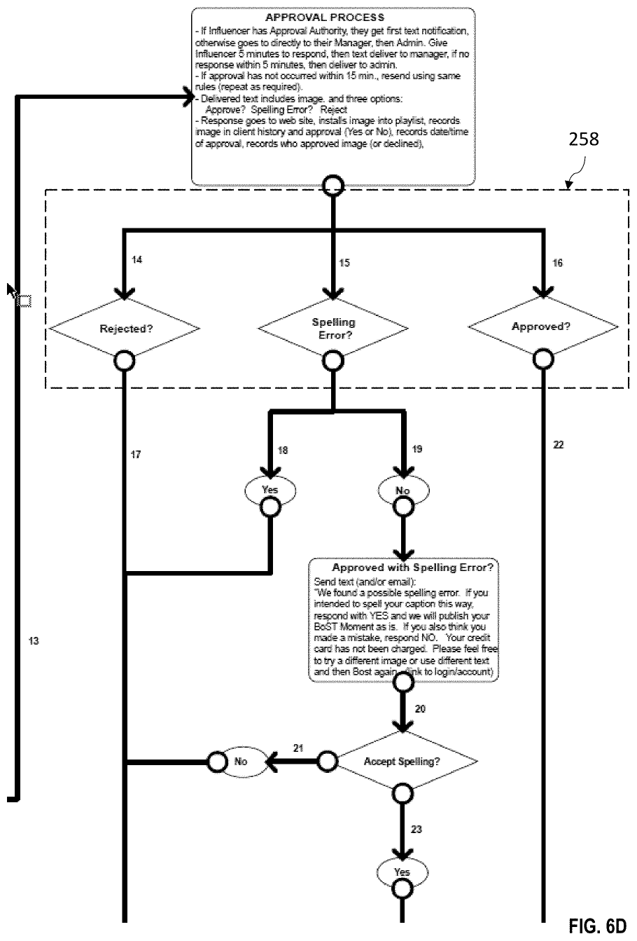

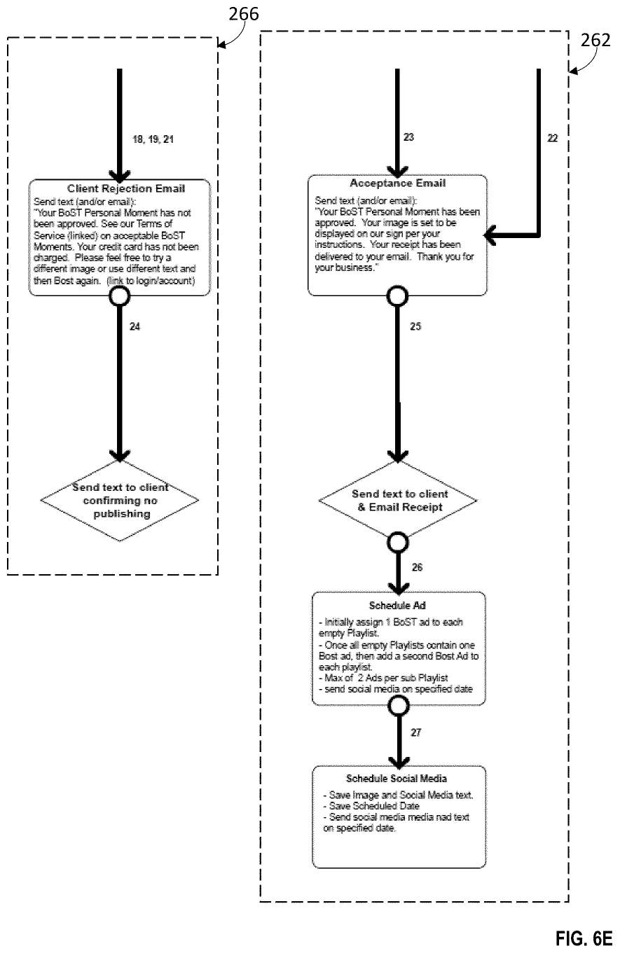

In one embodiment as shown in FIG. 6B, the individual dashboard 150 generally comprises at least the secondary channel connector 66 as described above in more detail, an account module 158, a moment module 162, a delivery module 166, and a payment module 170.

In one embodiment, the account module 158 provides an interface for the individual to create an account. Additionally, the individual, by accessing the account module 158, can view future moments and past moments. The individual may also utilize the account module 158 to access the moment module 162, the payment module 170, and the secondary channel connector 66. In some embodiments, the account module 158 is the same as the one or more login interface 76; however, in other embodiments, the account module 158 is different from the one or more login interface 76.

In one embodiment, the moment module 162, as shown in FIG. 6B, when selected by the individual, provides an interface for the individual to create the moment. The interface may provide a menu to the individual to select a moment category and select a particular one or more of the one or more digital signage 22a-n on which to display the moment. In one embodiment, the moment category may be one or more of: birthday, anniversary, in memoriam, congratulations, valentine, retirement, marry me, marriage announcement, and birth announcement, or the like.

In one embodiment, when the individual selects the particular one or more of the one or more digital signage 22a-n, the moment module 162 displays a map with a location corresponding to each of the one or more digital signage 22a-n indicated such that, when the individual selects a particular indication, the moment module 162 identifies the corresponding digital signage 22 as the digital signage 22 onto which the individual desires to display the moment.

In one embodiment, the moment module 162 displays a create moment interface to the individual thereby enabling the individual to upload an image, upload one or more text, and preview the moment before submitting the moment to be displayed on the digital signage 22.

In one embodiment, the moment module 162 displays a date selection interface to the individual thereby enabling the individual to select a start date on which to display the moment. In some embodiments, the user may be presented with an option to display the moment for a number of days, for example, for 1 day, 2 days, or 3 days, or the like. In one embodiment, the individual is notified of a price for each option. In yet another embodiment, the individual is notified that the price for each option may be dependent on a requested processing speed. Once the individual selects a desired option, the moment module 162 may trigger the delivery module 166.

In one embodiment, the delivery module 166, shown in FIG. 6B, will check the moment, selected digital signage 22, and selected start date/start time against the master playlist for the digital signage 22. For example, the delivery module 166 may check the maximum allowed playlists on the selected sign, less a playlist count on the digital signage 22 on the selected date to determine an available playlist count. If the playlist count, including the individual moment, would exceed the maximum number of playlists on the digital signage 22 on any date during which the moment would be scheduled for the digital signage 22, the deliver module 166 will notify the individual and direct the individual back to the moment module 162 to select a different start date.

In one embodiment, the delivery module 166 may then cause the moment to be submitted as a post to one or more secondary communication channel linked by the secondary channel connector 66 as described above in more detail. In one embodiment, the delivery module 166 provides an interface for the individual to select whether to deliver the moment as a post to only the individual's secondary communication channels, to not deliver the moment to any secondary communication channel, and/or to deliver the moment as a post to the secondary communication channels of any individual having an account with the management module 18.

In one embodiment, the delivery module 166 may be constructed and operate similar to the secondary channel distribution module 64 discussed in more detail above. When the individual submits a moment to the delivery module 166, the delivery module 166 may deliver the moment to one or more secondary communication channel, e.g., as a social media post. In one embodiment, the individual may include additional text as part of the moment when delivered to the one or more secondary communication channel.

In some embodiments, the delivery module 166 delivers the moment to one or more secondary communication channel associated with one or more secondary channel connector for one or more other client or for one or more other individual. For example, a client may enable Facebook as a first secondary channel connector and an individual may enable Twitter as a second secondary channel connector. In one embodiment, the client may submit a sub-playlist thus triggering the secondary channel distribution module 64 to deliver one or more message of the sub-playlist to both the first secondary channel connector, i.e., Facebook, and the second secondary channel connector, i.e., Twitter. In another embodiment, the individual may submit the moment thereby triggering the delivery module 166 to deliver the moment to both the first secondary channel connector, i.e., Facebook, and the second secondary channel connector, i.e., Twitter. Thus, the client may deliver one or more message from the client's sub-playlist and the individual may deliver the moment to their respective one or more secondary communication channel as well as to each other secondary communication channel associated with a client and/or an individual. In this manner, both clients and individuals can deliver one or more message or moment to a larger number of social media followers than either the client's or the individual's social media followers alone. In some embodiments, when the individual submits a moment, the delivery module 166 delivers the moment to all secondary channel connectors for each secondary communications channel for each client and/or individual.

In one embodiment, after the delivery module 166, the individual is directed to the payment module 170 as shown in FIG. 6C. The payment module 170 provides an interface for the individual to make a payment to display the moment. In one embodiment, the payment is not actually executed until after the moment is approved. In one embodiment, once the payment is made, the individual is notified that the order has been made and the moment will be displayed as indicated once the moment is approved by an approver.

Referring now to FIG. 4, shown therein is a flow diagram of an exemplary embodiment of an approval process 250. In generally, the approval process 250 includes: identifying an approver (step 254); determining whether an approval has occurred (step 258); and submitting moment to the master playlist (step 262) if the moment has been approved, or rejecting the moment (step 266) if the moment has not been approved.

In one embodiment, identifying an approver (step 254) includes identifying one or more user, such as a first user, having authority to approve the moment as an approver. Once the approver has been identified, the approver may be sent a first text notification. The first text notification may include an image of the moment and a question of whether to approve the moment or disapprove the moment. If identifying an approver (step 254) is initiated from a different step, then a second user having authority to approve the moment may be selected.

In one embodiment, determining whether an approval has occurred (step 258) includes determining whether the approver has responded to the first text notification within a predetermined period of time. If the approver has responded to the first text notification with an approval within the predetermined period of time, then the approval process 250 continues to submitting the moment to the master playlist (step 262), otherwise the approval process 250 continues back to the identifying an approver (step 254) to select a different approver. In one embodiment, the predetermined period of time is about 5 minutes whereas in another embodiment, the predetermined period of time is about 15 minutes. In one embodiment, the admin may determine the predetermined period of time.

In one embodiment, determining whether an approval has occurred (step 258) may send a rejection email to the individual and cancel any payment made in the payment module 170 if the moment is disapproved by one or more approver. In some embodiments, approval is an optional step and may not be required for submitting a moment to the master playlist.

In one embodiment, submitting moment to the master playlist (step 262) includes submitting the moment from the management module 18 to the processor 78 of the digital display 22 selected by the individual. The processor 78 may then include the moment in the master playlist for the digital signage 22.

In one embodiment, submitting moment to the master playlist (step 262) may further include sending an acceptance email to the individual along with a notification that the payment made in the payment module 170 is being processes and a receipt for the payment.

In one embodiment, submitting moment to the master playlist (step 262) may further include scheduling the moment by assigning one moment to each empty playlist position, once all empty playlists contain one moment, then add a second moment to each playlist. A maximum number of two moments per sub playlist may be included.

In one embodiment, submitting moment to the master playlist (step 262) may further include scheduling one or more message having the moment and moment text, to be distributed to the secondary communication channel on a specified date. For example, submitting the moment to the master playlist may include creating a social media post having the moment and moment text and posting the social media post on one or more social media platform on a specified date.

In one embodiment, rejecting the moment (step 266) may further include sending an email to the individual indicating that the moment has been rejected. The email may include one or more reason for the rejection. The email may include one or more link operable to direct the individual to create a new moment or edit the moment. In one embodiment, rejecting the moment (step 266) may further include sending one or more text message, or another communication, to the individual.

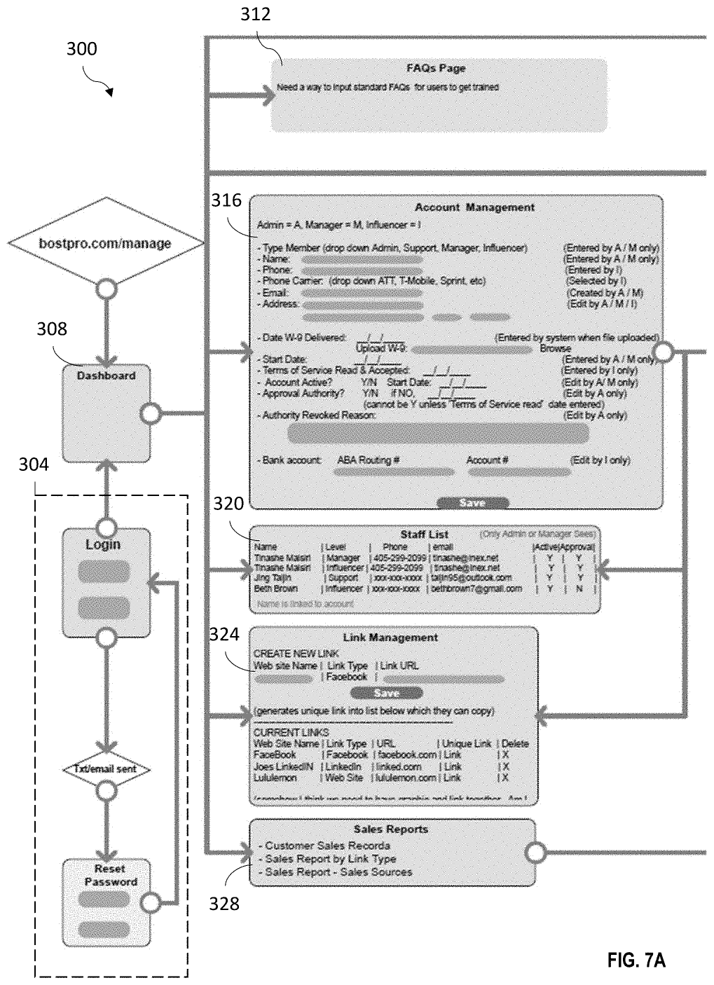

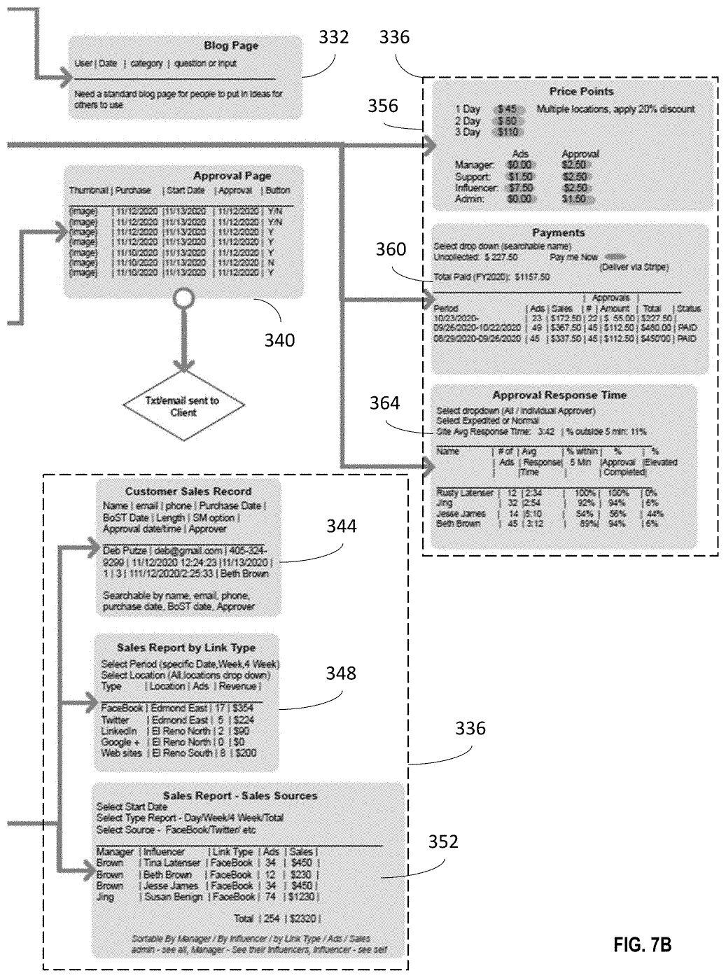

Referring now to FIGS. 7A-7B, shown therein is an account management module 300. The account management module 300 generally comprises a login module 304 enabling an account manager to log into the account management module 300 and a dashboard 308 providing access to at least an FAQ page module 312, an account manager module 316, a staff management module 320, a link management module 324, a sales report module 328, a blog page module 332, and a message statistics module 336. The account manager module 316 may further include an approval page module 340. The sales report module 328 may further include a sales record submodule 344, a sales report by link type submodule 348, and a sales report by sales source submodule 352.

In one embodiment, the account manager module 316 is in communication with at least the staff management module 320, the link management module 324 and the message statistics module 336.

In one embodiment, the message statistics module 336 includes a price points module 356 showing price points for each message type and message duration, a payments stats module 360 showing at least a number of payments for each payment period, and an approval stats module 364 showing statistics regarding approvals of one or more message and one or more approver. For example, for each approver, the message statistics module 336 may have a number of messages approved, average response time, percent of messages approved, and percent of messages referred for further processing, for example.

From the above description and examples, it is clear that the inventive concepts disclosed and claimed herein are well adapted to attain the advantages mentioned herein. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. A computing device comprising:
at least one processor, and
a non-transitory computer readable medium storing computer executable code that when executed by the at least one processor causes the at least one processor to:
receive a message conforming to requirements of a first communication channel, the message associated with an account, the account having pre-registered information identifying a second communication channel;
enable the message to be communicated through the first communication channel; and
enable the message to be communicated through the second communication channel.

2. The computing device of claim 1 wherein the first communication channel includes a digital billboard.

3. The computing device of claim 2, wherein the second communication channel is a social media platform.

4. The computing device of claim 3, wherein the account is a first account, and wherein the first account includes information identifying a user-name and password of a second account.

5. The computing device of claim 4, wherein the second account is registered in advance of the first account.

6. The computing device of claim 1, wherein the requirements are first requirements, and wherein the second communication channel has second requirements, and wherein the computer executable code that when executed by the at least one processor causes the at least one processor to modify the message to conform the message to the second requirements.
